(19) United States
(12) Patent Application Publication
(10) Pub. No.: US 2016/0055203 A1
(43) Pub. Date: Feb. 25, 2016

(54) METHOD FOR RECORD SELECTION TO AVOID NEGATIVELY IMPACTING LATENCY

(71) Applicant: Microsoft Corporation, Redmond, WA (US)

(72) Inventors: Yifan Shi, Bellevue, WA (US); Patrick Jordan, Mercer Island, WA (US); Tony Ferrell, Bothell, WA (US)

(21) Appl. No.: 14/466,306

(22) Filed: Aug. 22, 2014

(51) Int. Cl. G06F 17/30; H04L 12/801; H04L 12/26; H04L 29/08

(52) U.S. Cl. CPC G06F 17/30424; H04L 67/10; H04L 67/02; H04L 47/12; H04L 43/0888

(57) ABSTRACT

Various techniques for offline record selection to avoid negatively impacting latency are described herein. In one embodiment, a method includes receiving a search query from a client device via a network and in response to the received search query, determining if the received search query corresponds to one or more records of offline content. The records of offline content are previously determined and prior to receiving the search query. In response to determining that the received search query corresponds to at least one record of offline content, the method includes retrieving and providing the at least one record of offline content to the client device via the network.

### BACKGROUND

Online content serving delivers data to potential consumers via a computer network. One type of online content serving involves providing content in response to online search queries. For example, a user may submit a search query (e.g., FIFA World Cup) to a search engine (e.g., Bing.com). In response to the search query, the user can be provided with search results (e.g., FIFA's official website) along with marketing messages, texts, sounds, images, videos, hyperlinks, or other suitable types of data related to the search query.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Online content serving (e.g., online advertising) in response to search queries typically requires a low response latency to serve content such as marketing messages (referred to herein as advertisements or ads) because long delays may negatively impact user experience. However, time needed to select suitable content can vary considerably based on complexity and/or other characteristics of a particular query. For example, if a query involves a single keyword (e.g., FIFA), suitable content may be selected and served quickly. On the other hand, a query with multiple keywords may cause a longer delay in selecting content. In order to serve content under a suitable latency threshold, the content selection criteria and/or processes may need to be simplified. For example, few contextual features associated with the search query may be considered, and/or a simple selection model may be used. Such selection, however, may negatively impact the relevance or other qualities of the served content.

Several embodiments of the present technology utilize offline record selection to improve relevance, applicability, suitability, and/or other qualities of served content while reducing or avoiding negatively impacting response latency. The content can include one or more of ads, electronic messages, texts, sounds, images, videos, hyperlinks, or other suitable types of data. In certain embodiments, records of content may be pre-selected offline for particular pre-determined queries based on contextual features more extensive than those used for online content selection. For example, records of ads may be pre-selected offline based on impression history, click history, or other profiles of individual ads when served in response to a particular query. Thus, the pre-selected records of ads may be more relevant, applicable, suitable, or of a higher quality than those selected during online content selection. During operation, the pre-selected content may be served in addition to or in lieu of those selected during online content selection without negatively impacting the latency of serving the content, i.e., at a lower or generally similar response latency as the latency of online content selection.

### BRIEF DESCRIPTION OF THE DRAWINGS

FIG. 1 is a schematic diagram illustrating a computer framework having a content server utilizing offline content selection configured in accordance with embodiments of the present technology.

FIG. 2 is a block diagram showing software modules suitable for the content server of FIG. 1 in accordance with embodiments of the present technology.

FIG. 3 is a block diagram showing software routines suitable for the offline module of FIG. 2 in accordance with embodiments of the present technology.

FIGS. 4A-4C are flow diagrams illustrating embodiments of a process of serving content in accordance with embodiments of the present technology.

FIG. 5 is a schematic diagram illustrating another computer framework utilizing offline content selection and configured in accordance with embodiments of the present technology.

FIG. 6 is a computing device suitable for certain components of the computer framework in FIG. 1 or FIG. 5.

### DETAILED DESCRIPTION

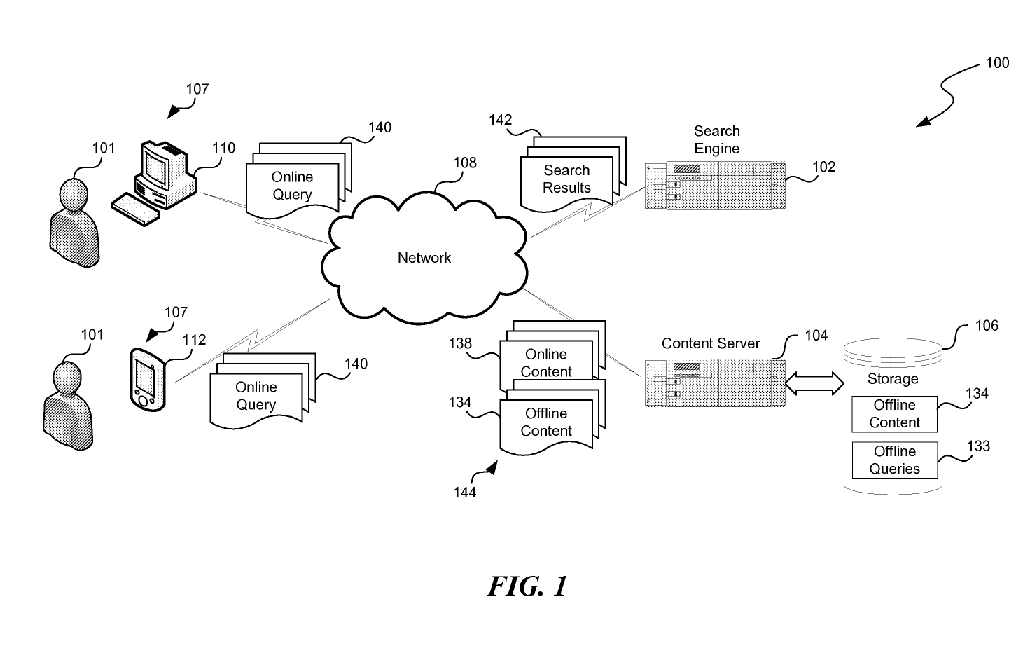

Certain embodiments of systems, devices, components, modules, routines, and processes for offline record selection to avoid negatively impacting latency are described below. In the following description, specific details of components are included to provide a thorough understanding of certain embodiments of the present technology. A person skilled in the relevant art will also understand that the technology may have additional embodiments. The technology may also be practiced without several of the details of the embodiments described below with reference to FIGS. 1-6.

As used herein, the term “record” generally refers to a single data item in an electronic form. For example, a record can be a database record with one or more fields or entries. The term “content” generally refers to any texts, sounds, images, videos, hyperlinks, or other suitable types of data. For example, content can include, but not limited to, ads, texts, sounds, images, videos, hyperlinks, or other suitable types of data. Also used herein, the term “online content selection” generally refers to a process of selecting content while being connected to a network (e.g., the Internet) and in response to receiving a search query via the network. The content selected by online content selection are referred to herein as “online content.” The search query triggering online content selection is referred to herein as an “online query.” Also used herein, the term “offline content selection” generally refers to a process of selecting content independent of online content selection. For example, offline content selection can include pre-selecting records of content based on one or more pre-determined queries prior to receiving an online query. The pre-selected content are referred to herein as “offline content.” The pre-determined queries are referred to herein as “offline queries.”

Also used herein, the term “contextual features” or “features” generally refers to any information related to one or more of circumstances, conditions, factors, states, situations, or other characteristics of an item of interest (e.g., a search query). For example, a contextual feature of a search query may include one of a geographic region from which the search query is received; timing of the received search query; a computing platform with which the search query is selected; an aggregate online user behavior (e.g., searching frequency) of the search query; or other suitable information related to the search query. In addition, the term “contextual feature set” or “feature set” generally refers to a set of one or more contextual features.

Serving content (e.g. ads) online in response to search queries typically requires a fast response and thus low latency. In general, relevance, applicability, suitability, and/or other quality of the served content can be improved as additional contextual features are used during selection. However, selecting records of content based on extensive contextual features may require processing times longer than a suitable latency threshold (e.g., 100 milliseconds). Thus, in order to reduce processing times, fewer contextual features are typically considered during selection, and thus reducing the quality of the served content.

Several embodiments of the present technology utilize offline content selection to improve relevance, applicability, suitability, and/or other qualities of the served content. As discussed in more detail below, records of offline content may be pre-selected for pre-determined offline queries based on extensive context features. The pre-selected offline content may be served in addition to or in lieu of online content selected by online content selection based on fewer contextual features. As a result, the served content may be more relevant, applicable, or suitable than those selected solely by online content selection while maintaining or even reducing response latency.

FIG. 1 is a schematic diagram illustrating a computer framework 100 having a content server 104 utilizing offline content selection configured in accordance with embodiments of the present technology. As shown in FIG. 1, the computing framework 100 can include a search engine 102, a content server 104, and one or more client devices 107 interconnected via a network 108. In one embodiment, the network 108 can be the Internet. In other embodiments, the network 108 can also include a local area network, a wide area network, and/or other suitable types of network. Even though particular components of the computing framework 100 are shown in FIG. 1, in other embodiments, the computing framework 100 can also include additional servers, client devices, networking devices, and/or other suitable components.

The client devices 107 can be configured to allow users 101 to communicate with and access the search engine 102 and/or the content server 104 via the network 108. For example, as shown in FIG. 1, the users 101 can transmit online queries 140 to the search engine 102 via the network 102. In response to the received online queries 140, the search engine 102 can provide search results 142, and the content server 104 can serve content 144 related to the online queries 140 to the respective client devices 107. In the illustrated embodiment, a desktop computer 110 and a mobile computing device 112 (e.g., a smart phone or a tablet) are shown as example client devices 107. In other embodiments, additional and/or different types of client devices 107 may be operatively coupled to the network 108.

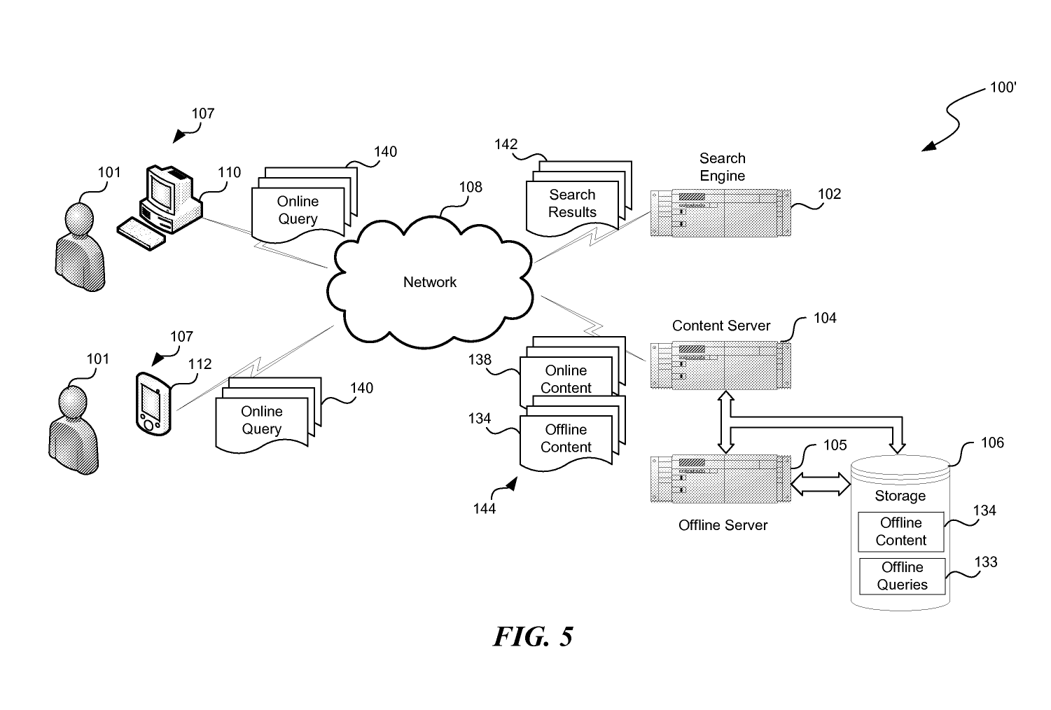

In certain embodiments, the search engine 102 and the content server 104 may be independent from each other. For example, a search engine provider (not shown) may provide the search engine 102 while an advertising network (not shown) may provide the content server 104. In other embodiments, the search engine 102 and the content server 104 may be provided by a single entity such as Google. In further embodiments, the computing framework 100 may have other suitable arrangements, one example of which is described in more detail below with reference to FIG. 5.

The search engine 102 can be configured to provide the search results 142 to the client devices 107 via the network 108. The search results 142 can include web pages, images, videos, and/or other suitable types of data determined to be related to the online queries 140 by the search engine 102. Examples of search engine 102 can include Bing.com and Google.com. In one embodiment, the search engine 102 can include a web server configured to perform web crawling, indexing, and/or searching. In another embodiment, the search engine 102 can include a software service configured to perform the foregoing functions. In further embodiments, the search engine 102 may include other suitable hardware/software components.

The content server 104 can be configured to serve content 144 to the client devices 107 via the network 108 in response to the online queries 140. In certain embodiments, the content server 104 may be configured to select and serve online content 138 in response to the online queries 140. In other embodiments, the content server 104 may be configured to select offline content 134 for particular offline queries 133 prior to receiving the online queries 140. The pre-selected offline content 134 can then be stored in a computer readable storage medium designated as a storage 106 (e.g., a computer cache memory). The content server 104 may also be configured to retrieve at least one of the offline content 134 from the storage 106 and serve the retrieved offline content 134 in response to the received online queries 140 to the client devices 107 in addition to or in lieu of online content 138. In further embodiments, content server 104 may also be configured to select offline content 134 generally parallel to the online content selection or in other suitable fashions.

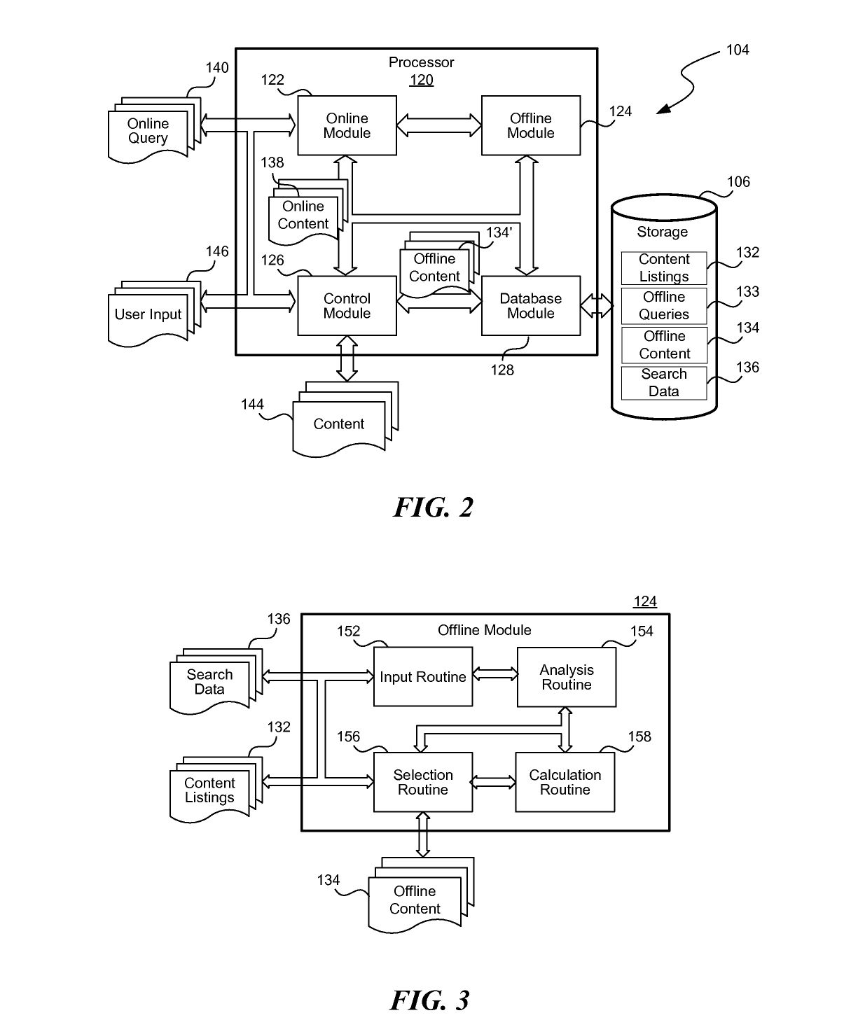

The content server 104 can include a web server, an application server, a catalog server, a communication server, and/or other suitable types of server. As shown in FIG. 1, the content server 104 can be operatively coupled to the storage 106 storing records of the pre-selected offline content 134. The storage 106 can reside in any suitable storage hardware or device(s), examples of which can include read-only memory, random-access memory, magnetic disk storage media, optical storage media, flash memory devices, and/or other suitable computer readable storage media. The storage 106 can also store records of other suitable advertising information, as described in more detail below with reference to FIG. 2.

In operation, one of the users 101 can use the client device 107 to submit an online query 140 to the search engine 102 via the network 108. In response to receiving the online query 140, the search engine 102 determines one or more search results 142 based on the received online query 140. Also in response to receiving the online query 140, the content server 104 can determine if the received online query 140 corresponds to one or more records of offline content 134 in the storage 106. If the received online query 140 corresponds to at least one record of the offline content 134, in certain embodiments, the content server 104 can serve the at least one offline content 134 to the client device 107 via the network 108 along with the search results 144.

As discussed above, the offline content 134 may be pre-selected based on extensive contextual features, and thus can be more relevant, applicable, or suitable than the online content 138 selected during online content selection. Also, because the offline content 134 are pre-selected prior to receiving the online query 140, processing time of pre-selecting the offline content 134 does not negatively impact response time of the content server 104. As a result, a response latency of the content server 104 may be lower than or generally similar to a latency of online content selection while the quality of the served content 144 is improved. For example, in certain implementations, the latency of serving the offline content 134 can be less than 10 milliseconds because retrieving the offline content 134 from the storage 106 typically requires a short processing time for the content server 104. In contrast, the latency of serving only the online content 138 may be around or even greater than 100 milliseconds in order to provide results of online content 138 that are generally similar to the offline content 134. If less time (e.g., 50 milliseconds) is allowed for the online content selection, in certain situations, the content server 104 may return few or even no results for the online content 138. Thus, by serving the offline content 134 in addition to or in lieu of the online content 138, the served content 144 can be more relevant than those selectable using only online content selection, without negatively impacting the latency to respond to the received online queries 140.

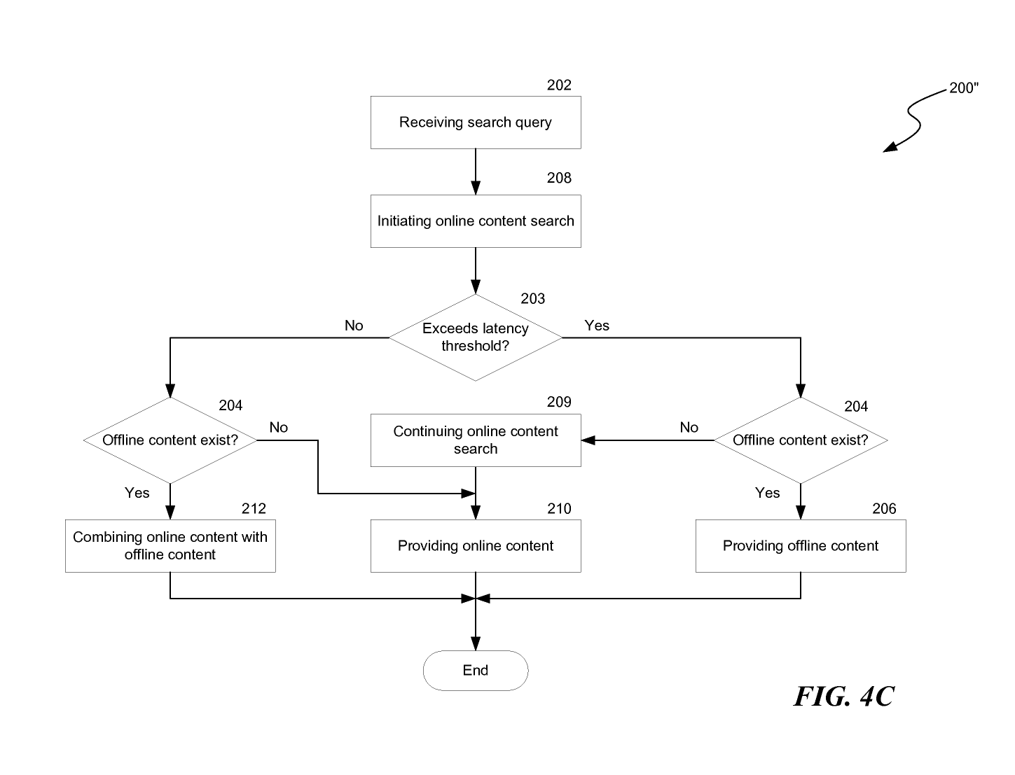

In other embodiments, in response to the received online query 140, the content server 104 can also initiate online content selection to select one or more online content 138 and provide a combination of the online content 138 and offline content 134 to the client device 107. In further embodiments, if the received online query 140 does not correspond to one or more records of offline content 134 in the storage 106, the content server 104 may provide only the online content 138 to the client device 107. Various modes of operation of the content server 104 are described in more detail below with reference to FIGS. 4A-4C.

FIG. 2 is a block diagram showing software modules suitable for the content server 104 of FIG. 1 in accordance with embodiments of the present technology. In FIG. 2 and in other Figures hereinafter, individual software components, modules, and routines may be a computer program, procedure, or process written as source code in C, C++, C sharp, Java, and/or other suitable programming languages. The computer program, procedure, or process may be compiled into object or machine code and presented for execution by a processor of a personal computer, a network server, a laptop computer, a smart phone, and/or other suitable computing devices. Various implementations of the source and/or object code and associated data may be stored in a computer memory that includes read-only memory, random-access memory, magnetic disk storage media, optical storage media, flash memory devices, and/or other suitable storage media.

As shown in FIG. 2, the content server 104 can include a computing processor 120 operatively coupled to the storage 106 holding various records of information. In the illustrated embodiment, the computing processor 120 can include an online module 122, an offline module 124, a control module 126, and a database module 128 interconnected with one another. Even through particular topology of the foregoing modules are shown in FIG. 2, in other embodiments, the modules may have other suitable arrangements. In further embodiments, the computing processor 120 can also include one or more input modules, output modules, and/or other suitable types of modules.

The online module 122 can be configured to perform online content selection. For example, the online module 122 can select and/or otherwise determine one or more records of online content 138 from the content listings 132 in response to receiving the online query 140 via the network 108 (FIG. 1). As discussed above, the low latency requirements may cause the online module 122 to sacrifice contextual features for responsiveness during online content selection. As a result, the online content 138 may lack appropriate qualities. For instance, in one embodiment, the online module 122 may select the online content 138 from the content listings 132 based solely on one or more keywords in the online query 140. In other embodiments, the online module 122 may select records from the content listings 132 based on geographic, time-of-day, and/or other suitable types of information associated with the online query 140. However, in any of the foregoing examples, the information considered during online content selection may be limited, and thus may result in low quality of the provided content 144.

The offline module 124 may be configured to remedy or at least ameliorate some of the drawbacks of online content selection by performing offline content selection. In certain embodiments, the offline module 124 can be configured to pre-determine a set of offline queries 133 and pre-select a set of offline content 134 for the individual offline queries 133 based on contextual features more extensive than those used during online content selection. The offline module 124 can perform such offline content selection prior to receiving the online query 140. As a result, the offline module 124 may select the offline content 134 for the offline queries 133 without affecting the latency of serving the content 144 in response to the online query 140 online. During operation, at least a subset of the pre-selected offline content 134 (shown in FIG. 2 as offline content 134′) may be provided to the control module 126 to be served in response to the received online query 140.

In certain embodiments, the offline module 124 can be configured to determine the offline queries 133 based various factors and/or sources of information. In one example, the offline module 124 can determine the offline queries 133 by analyzing historical search data 136 for a search frequency of individual online queries 140 over a period of time (e.g., one week, two weeks, or one month). The content server 104 may obtain such historical search data 136 from the storage 106, from the search engine 102 (FIG. 1), or from other suitable sources. If a search query (e.g., FIFA) has been searched more than a frequency threshold (e.g., 1000 searches/hour), then the offline module 124 may store the search query as a record of the offline queries 133 in the storage 106. During such analysis and other analysis discussed herein, the offline module 124 (or other modules of the content server 104) may use aggregate and anonymous historical search data 136 or other suitable historical information not including any personal identifiable information. Users (e.g., the users 101 in FIG. 1) can be allowed to opt-in or opt-out of collection of such historical information. For example, the users 101 (FIG. 1) may affirmatively elect to allow the collection of impression history, click history, or other suitable historical information of any served content 144. In another example, the users 101 may elect not to participate in default collection of such historical information. In further examples, the users 101 may also control the storage, use, analysis, and/or dissemination of any such collected historical information related to the users 101.

In another example, if the offline module 124 receives an indication of an upcoming event (e.g., FIFA World Cup), then the offline module 124 may determine and add related online queries 140 (e.g., FIFA, soccer World Cup, etc.) to the offline queries 133. In other embodiments, the offline module 124 may receive the offline queries 133 via user input 146. In further embodiments, the offline queries 133 may be updated periodically or continuously by the offline module 124 or other suitable modules (not shown). In yet further embodiments, the offline queries 133 may be updated manually (e.g., by an operator), or updated in other suitable manners.

The offline module 124 can also be configured to utilize more computational intensive techniques to select the offline content 134 than online content selection. In certain embodiments, the offline module 124 can be configured to select the offline content 134 based on additional and/or more complex contextual features than online content selection. In one example, in addition to the contextual features considered during online content selection, the offline module 124 can also analyze historical search data 136 to determine an online behavior associated with a particular content. Such online behavior includes, for instance, how many impressions associated with the content in a period of time when served based on a particular query. The online behavior can also include that, of those impressions, how often the content is clicked on or resulted in a purchase. In another example, the offline module 124 can also determine and/or consider a probability of a user clicking on the content when served in response to a particular query. In a further example, the offline module 124 may also consider user feedback (e.g., likes or dislikes) of a served content.

In other embodiments, the offline module 124 can also utilize selection models and/or techniques that are more complex than those used during online content selection. For example, in one embodiment, the offline module 124 may utilize deep machine learning of the historical search data to select an offline selection model with higher level abstractions and/or more complex inner data structures than those used for online content selection. As a result, higher quality content may be selected than online content search. In further embodiments, the offline module 124 may receive human input for selecting the offline content 134.

The control module 126 can be configured to select the content 144 in response to the received online query 140. The content 144 may include the online content 138, the offline content 134′, or a combination thereof. For example, in one embodiment, the control module 126 may serve only the offline content 134′ as the content 144 in response to the online query 140. In another embodiment, the control module 126 may serve a combination of the online content 138 and the offline content 134′ in a suitable order as the content 144. In further embodiments, the control module 126 may serve only the online content 138 as the content 144.

The database module 128 can be configured to organize records, including records of the content listings 132, the offline queries 133, the offline content 134, and the search data 136, and facilitates storing and retrieving of these records to and from the storage 106. In certain embodiments, the search data 136 can include historical statistics of search queries, for example, listing of search queries and how often the search queries are received at the search engine 102 (FIG. 1). The content listings 132 include a list of content suitable to be served in response to any received online queries 140. In other embodiments, the search data 136 and/or the content listings 132 may include other suitable information. Any type of database organization may be utilized, including a flat file system, hierarchical database, relational database, or distributed database, such as provided by a database vendor such as the Microsoft Corporation, Redmond, Wash.

In operation, the control module 126 receives the online query 140. In response, in one embodiment, the control module 126 determines if the online query 140 substantially matches one of the offline queries 133 in the storage 106. In certain embodiments, the online query 140 substantially matches one of the offline queries 133 when the online query 140 and the one of the offline queries include at least one common keyword or token. In other embodiments, the online query 140 substantially matches one of the offline queries 133 when the online query 140 matches the one of the offline queries 133 in length and/or sequence of characters for a threshold percentage (e.g., 80%). In further embodiments, the online query 140 can be deemed substantially matching one of the offline queries 133 based on other suitable matching criteria.

In response to determining that the online query 140 substantially matches one of the offline queries 133, the control module 126 can cause the database module 128 to retrieve a subset of the offline content 134 in the storage 106 that correspond to the one of the offline queries 133 and serve the retrieved offline content 134′ as the content 144. As such, the content server 104 can eliminate or at least reduce reliance on online content selection while serving the offline content 134′ with higher quality than any online content 138 selected by the online module 122. As a result, computational load of the content server 104 may be reduced while improving the quality of served content 144 when compared to conventional techniques. In other embodiments, the retrieved offline content 134′ may be combined with the online content 138. In further embodiments, in response to determining that the online query 140 does not substantially match one of the offline queries 133, the control module 126 may serve the online content 138. Details of the foregoing and other operational modes are described in more detail below with reference to FIGS. 4A-4C.

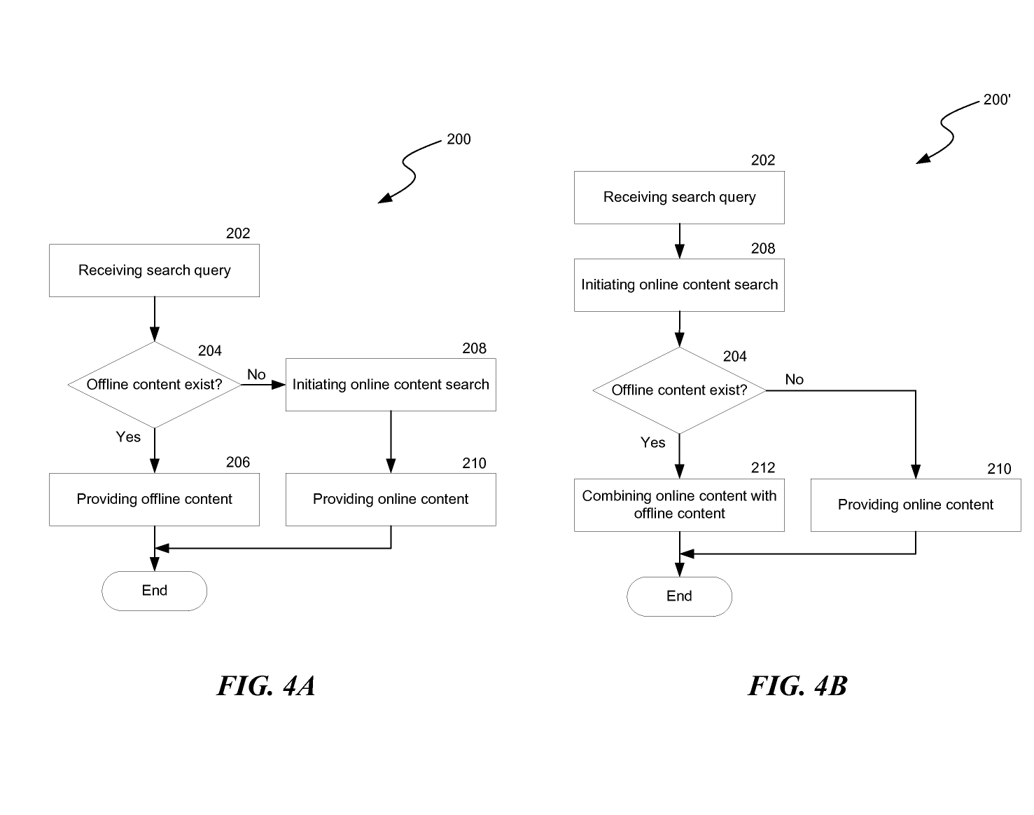

FIG. 3 is a block diagram showing software routines suitable for the offline module 124 of FIG. 2 in accordance with embodiments of the present technology. As shown in FIG. 3, the offline module 124 can include an input routine 152, an analysis routine 154, a selection routine 156, and a calculation routine 158 interconnected with one other. The individual routines may be a computer program or procedure, written as source code in a conventional programming language.

The input routine 152 can be configured to receive the search data 136, the content listings 132 from the storage 106 (FIG. 2) and/or other suitable sources. The analysis routine 154 may be configured to determine a set of offline queries 133 (FIG. 2) based on the received search data 136, as discussed with reference to FIG. 2. The calculation routine 158 can include counters, timers, summers, subtractors, and/or other suitable procedures configured to perform various types of calculations to facilitate operation of other routines. In one embodiment, the calculation routine 158 may include a counter configured to accumulate a number of searches for a search query over a period of time. In another embodiment, the calculation routine 158 may include a comparison procedure configured to compare the accumulated number of searches to a threshold. In other embodiments, the calculation routine 158 may include other procedures for performing time averaging, window averaging, filtering, and/or other suitable operations.

The selection routine 156 can be configured to select the offline content 143 from the content listings 132 for the offline queries 133 (FIG. 2). As discussed above with reference to FIG. 2, the selection routine 156 can select the offline content 134 from the content listings 132 utilizing more computational intensive techniques than online content selection. As a result, the pre-selected offline content 134 may have higher quality than those selected during online content selection.

In operation, the input routine 152 receives the search data 136 from the storage 106 periodically or in other suitable manners. The input routine 152 then passes the received search data 136 to the analysis routine 154. The analysis routine 154 in turn determines the offline queries 133 facilitated by the calculation routine 158. The selection routine 156 can then selects a subset of content from the content listings 132 and output the selected subset of content as the offline content 134 for the individual offline queries. Records of the offline content 134 may then be stored in the storage 106.

Even though the operations of determining the offline queries 133 and offline content 134 are described above as being in sequence, in other embodiments, the operations may be performed in other suitable temporal relationships. For example, in one embodiment, the input routine 152 may receive multiple search data 136 over a period of time. The analysis routine 154 may then determine the offline queries 133 based on the multiple search data 136 while the selection routine 156 does not determine the offline content 134 for the offline queries 133 until a target time, number of records of the offline queries, and/or other suitable events. In further embodiments, the foregoing operations may be performed in an interleaved, staggered, or other suitable manners.

FIGS. 4A-4C are flow diagrams illustrating embodiments of a process of serving content in accordance with embodiments of the present technology. In FIGS. 4A-4C, similar operations are identified with identical reference numbers. Even though the operations of the processes in FIGS. 4A-4C are described with reference to certain modes of operation of the content server 104 in FIGS. 1 and 2, in other embodiments, the processes may be performed in other suitable computing devices, systems, or frameworks. In further embodiments, the content server 104 may have other suitable modes of operations.

As shown in FIG. 4A, the process 200 includes receiving a search query, for example, with the control module 126 at stage 202. The search query may include a text string, a search category (e.g., web site, photo, video, etc.), and/or other suitable information. The process 200 can then include a decision stage 204 to determine if offline content corresponding to the received search query exist, for example, in the storage 106 (FIG. 2). In response to determining that offline content corresponding to the received search query exist, the process 200 includes retrieving, with the database module 128, the offline content from the storage 106 and, with the control module 126, providing the offline content in response to the received search query at stage 206. In response to determining that offline content corresponding to the received search query do not exist, the process 200 includes initiating an online content search, for example, with the online module 122 to select online content at stage 208. The process 200 then includes providing the online content in response to the received search query at stage 210.

As shown in FIG. 4B, the process 200′ includes receiving a search query at stage 202. The process 200′ can then include initiating an online content search to select online content at stage 208. The process 200′ can then include a decision stage 204 to determine if offline content corresponding to the received search query exist. In response to determining that offline content corresponding to the received search query exist, the process 200′ includes combining, with the control module 126, the online content with the offline content to select the combined content 144 (FIG. 2) at stage 212. The combined content 144 are then provided in response to the received search query. In response to determining that offline content corresponding to the received search query do not exist, the process 200′ includes providing the selected online content in response to the received search query at stage 210.

As shown in FIG. 4C, the process 200″ includes receiving a search query at stage 202 and initiating an online content search to select online content at stage 208. The process 200″ can then include a decision stage 203 to monitor and determine, for example, with the control module 126, if the online content search exceeds a target latency threshold (e.g., 10 milliseconds to 100 milliseconds, or other suitable values).

In response to determining that the online content search exceeds a suitable latency threshold, the process 200″ includes determining if offline content corresponding to the received search query exist at stage 204. In response to determining that offline content corresponding to the received search query exist, the process 200″ includes providing the offline content in response to the received search query at stage 206. In response to determining that offline content corresponding to the received search query do not exist, the process 200″ includes continuing the online content search to select the online content at stage 209. The process 200″ then includes providing the selected online content in response to the received search query at stage 210.

In response to determining that the online content search does not exceed the target latency threshold, the process 200″ includes determining if offline content corresponding to the received search query exist at stage 204. In response to determining that offline content corresponding to the received search query exist, the process 200″ includes combining the online content with the offline content to select the combined content 144 and providing the content 144 in response to the received search query at stage 212. In response to determining that offline content corresponding to the received search query do not exist, the process 200″ includes providing the selected online content in response to the received search query at stage 210.

FIG. 5 is a schematic diagram illustrating another computer framework 100′ utilizing offline content selection and configured in accordance with embodiments of the present technology. As shown in FIG. 5, the computing framework 100′ can include components generally similar to those shown in FIG. 1 except the content server 104 is operatively coupled to an offline server 105 configured to select the offline content 134. For example, in one embodiment, the offline server 105 can include a processor (not shown) having the offline module 124 (FIG. 2) and the database module 128 (FIG. 2). In other embodiments, the offline server 105 may include other suitable modules. In one embodiment of operation, the offline server 105 may provide the offline content 134 to the content server 104. In another embodiment, the content server 104 may access the storage 106 directly to retrieve records of the offline content 134 and/or in other suitable manners.

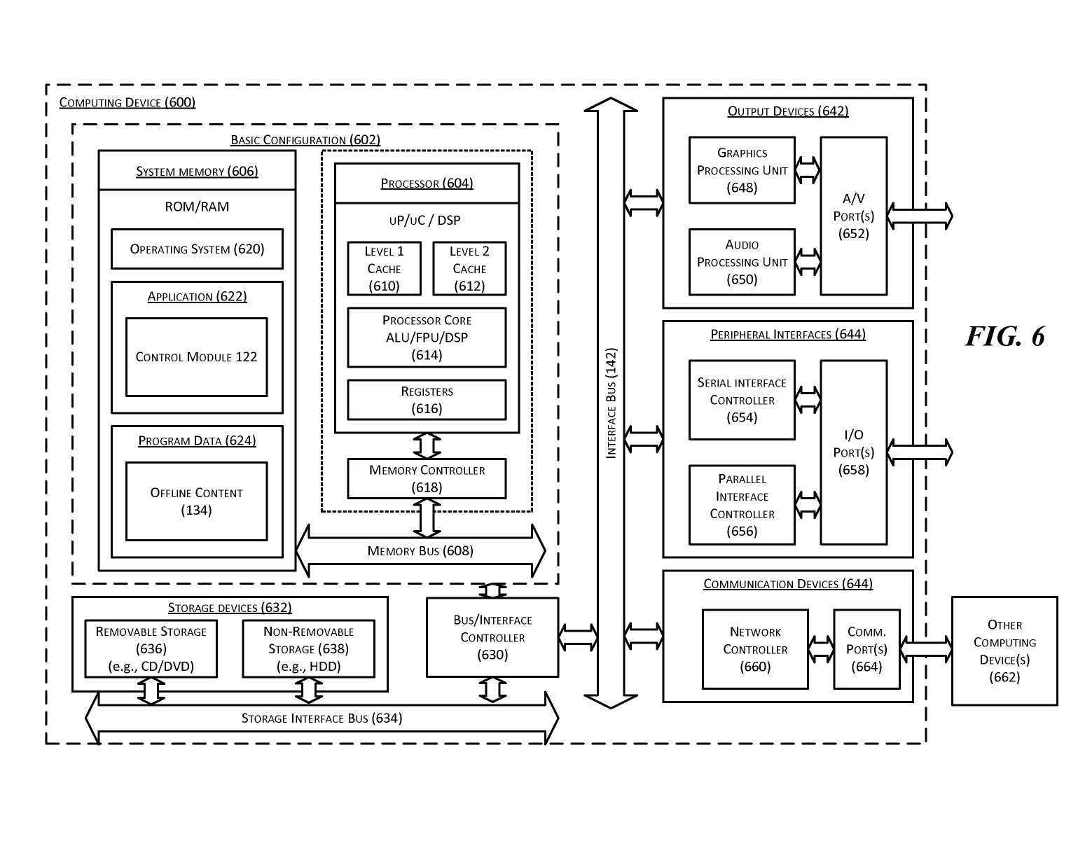

FIG. 6 is a computing device 600 suitable for certain components of the computing framework 100 in FIG. 1 or FIG. 5. For example, the computing device 600 may be suitable for the search engine 102 of FIG. 1, the content server 104 of FIG. 1, or the offline server 105 of FIG. 5. In a very basic configuration 602, computing device 600 typically includes one or more processors 604 and a system memory 606. A memory bus 608 may be used for communicating between processor 604 and system memory 606.

Depending on the desired configuration, the processor 604 may be of any type including but not limited to a microprocessor (μP), a microcontroller (μC), a digital signal processor (DSP), or any combination thereof. The processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, one or more applications 622, and program data 624. The program data 624 may include, for example, the offline content 134. The application 622 may include, for example, the control module 122. This described basic configuration 602 is illustrated in FIG. 6 by those components within the inner dashed line.

The computing device 600 may have additional features or functionality, and additional interfaces to facilitate communications between basic configuration 602 and any other devices and interfaces. For example, a bus/interface controller 630 may be used to facilitate communications between the basic configuration 602 and one or more data storage devices 632 via a storage interface bus 634. The data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, removable storage devices 636, and non-removable storage devices 638 are examples of computer readable storage media. Computer readable storage media include storage hardware or device(s), examples of which include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which may be used to store the desired information and which may be accessed by computing device 600. Any such computer readable storage media may be a part of computing device 600. The term “computer readable storage medium” excludes propagated signals and communication media.

The computing device 600 may also include an interface bus 640 for facilitating communication from various interface devices (e.g., output devices 642, peripheral interfaces 644, and communication devices 646) to the basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 600 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method performed by a computing system having a processor and a computer readable storage medium, the method comprising:
with the processor,
receiving a search query from a client device via a network;
in response to the received search query,
determining if the received search query corresponds to one or more records of offline content accessible from the computer readable storage medium, the offline content being pre-selected prior to receiving the search query from the client device via the network and being more relevant than those selectable during online content selection; and
in response to determining that the received search query corresponds to at least one record of one of the offline content accessible from the computer readable storage medium, providing the one of the offline content that are more relevant than those selectable during online content selection to the client device via the network without negatively impacting a latency to respond to the received search query.

2. The method of claim 1, further comprising:
in response to determining that the received search query does not correspond to one or more records of offline content in the computer readable storage medium,
initiating an online content search based on the received search query to select one or more records of online content; and
providing the selected one or more records of the online content to the client device via the network.

3. The method of claim 1 wherein determining if the received search query corresponds to one or more records of offline content includes:
determining if the received search query substantially matches an offline query previously used to determine the one or more records of offline content offline from the network, the offline query being associated with the at least one record of offline content; and
in response to determining that the received search query substantially matches the offline query, indicating that the received search query corresponds to the at least one record of offline content in the computer readable storage medium.

4. The method of claim 1, further comprising:
in response to the received search query, initiating an online content search based on the received search query to select one or more records of online content; and
in response to determining that the received search query corresponds to at least one record of offline content in the computer readable storage medium,
selecting a list of content having both the one or more records of online content and the at least one record of offline content; and
providing the selected list of content to the client device via the network.

5. The method of claim 1, further comprising:
in response to the received search query, initiating an online content search based on the received search query to select one or more records of online content; and
in response to determining that the received search query does not correspond to at least one record of offline content in the computer readable storage medium, providing the selected one or more records of the online content to the client device via the network.

6. The method of claim 1, further comprising:
in response to the received search query, initiating an online content search based on the received search query to select one or more records of online content;
determining if the initiated online content search exceeds a latency threshold; and
in response to determining that the initiated online content search exceeds the latency threshold and in response to determining that the received search query corresponds to at least one record of offline content in the computer readable storage medium, providing the at least one record of offline content to the client device via the network.

7. The method of claim 1, further comprising:
in response to the received search query, initiating an online content search based on the received search query to select one or more records of online content;
determining if the initiated online content search exceeds a latency threshold; and
in response to determining that the initiated online content search exceeds the latency threshold and in response to determining that the received search query corresponds to at least one record of offline content in the computer readable storage medium, terminating the initiated online content search.

8. The method of claim 1, further comprising:
in response to the received search query, initiating an online content search based on the received search query to select one or more records of online content;
determining if the initiated online content search exceeds a latency threshold; and
in response to determining that the initiated online content search exceeds the latency threshold and in response to determining that the received search query does not correspond to at least one record of offline content in the computer readable storage medium,
continuing the initiated online content search to select one or more records of online content; and
providing the selected one or more records of online content to the client device via the network.

9. The method of claim 1, further comprising:
in response to the received search query, initiating an online content search based on the received search query to select one or more records of online content;
determining if the initiated online content search exceeds a latency threshold; and
in response to determining that the initiated online content search does not exceed the latency threshold and in response to determining that the received search query does not correspond to at least one record of offline content in the computer readable storage medium, providing the selected one or more records of online content to the client device via the network.

10. A computing system, comprising:
a processor and a memory operatively coupled to the processor, the memory containing instructions that when executed by the processor, causing the processor to perform a process that includes:
determining a set of offline queries based at least on historical data of search frequency of the individual offline queries;
for each of the offline queries, determining one or more records of offline content corresponding to each of the offline queries;
receiving an online query from a client device via the network, the online query substantially matching one of the determined offline queries; and
in response to the received online query,
determining one or more records of online content based on the received online query, the one or more records of offline content being more relevant than the determined one or more online content; and
providing the one or more records of offline content that are more relevant than the one or more online content or a combination of records of the online content and offline content to the client device via the network without negatively impacting a latency to respond to the received online query.

11. The computing system of claim 10 wherein determining the set of offline queries includes:
accessing the historical data of search frequency of a plurality of queries;
comparing the accessed historical data of search frequency to a frequency threshold; and
in response to the historical data of search frequency of one of the queries exceeding the frequency threshold, designating the one of the queries as one of the offline queries.

12. The computing system of claim 10 wherein:
determining the one or more records of offline content includes determining the one or more offline content based on a first contextual feature set related to the individual offline queries;
determining the one or more records of online content includes determining the one or more online content based on a second contextual feature set related to the online query; and
the first contextual feature set is more extensive than the second contextual feature set.

13. The computing system of claim 10 wherein:
determining the records of one or more offline content includes determining the one or more offline content using a first selection model;
determining the records of one or more online content includes determining the one or more online content using a second selection model; and
the first selection model is more computation intensive than the second selection model.

14. The computing system of claim 10 wherein the process performed by the processor further includes:
determining if a delay associated with determining the one or more online content exceeds a latency threshold; and
in response to determining that the delay exceeds the latency threshold, providing the one or more records of offline content to the client device via the network without the one or more records of online content.

15. The computing system of claim 10 wherein the process performed by the processor further includes:
determining if a delay associated with determining the one or more online content exceeds a latency threshold; and
in response to determining that the delay does not exceed the latency threshold, providing a combination of records of the online content and offline content to the client device via the network.

16. The computing system of claim 10 wherein the process performed by the processor further includes:
updating the set of offline queries based at least on additional historical data of search frequency of the individual offline queries; and
for each of the offline queries in the updated set, determining one or more records of offline content.

17. The computing system of claim 10 wherein the process performed by the processor further include for each of the offline queries in the set, periodically updating the one or more records of offline content.

18. A method performed by a computing system having a processor and a computer readable storage medium, the method comprising:
with the processor,
determining a set of offline queries based at least on historical data of search frequency of the individual offline queries;
for each of the offline queries, determining one or more records of offline content corresponding to each of the offline queries, the one or more records of offline content being more relevant than those selectable during online content selection;
receiving an online query from a client device via the network; and
in response to the received online query,
determining if the received online query corresponds to one of the offline queries; and
in response to determining that the received online query corresponds to one of the offline queries, providing the determined one or more records of offline content corresponding to the one of the offline queries and are more relevant than those selectable during online content selection to the client device via the network without negatively impacting a latency to respond to the received online query.

19. The method of claim 18, further comprising:
in response to the received online query, determining one or more records of online content corresponding to the online query; and
in response to determining that the received online query corresponds to one of the offline queries, providing a combination of the determined one or more records of online content and offline content corresponding to the one of the offline queries to the client device via the network.

20. The method of claim 18 wherein:
in response to the received online query, determining one or more records of online content corresponding to the online query;
determining if a delay in determining the one or more online content exceeds a latency threshold;
in response to determining that the received online query corresponds to one of the offline queries and in response to determining that the delay exceeds the latency threshold, providing only the one or more records of offline content corresponding to the one of the offline queries to the client device via the network; and
in response to determining that the received online query corresponds to one of the offline queries and in response to determining that the delay does not exceed the latency threshold, providing a combination of the determined one or more records of online content and offline content corresponding to the one of the offline queries to the client device via the network.
